(19) United States
(12) Patent Application Publication
(10) Pub. No.: US 2009/0071593 A1
(43) Pub. Date: Mar. 19, 2009

(54) Pultrusion Apparatus and Method

(75) Inventors: David Slaback, St. Albert (CA); Wayne Werstiuk, Spruce Grove (CA)

Correspondence Address: Larson & Anderson, LLC, P.O. BOX 4928, DILLON, CO, 80435, US

(73) Assignee: RESIN SYSTEMS, INC, Calgary, AB (CA)

(21) Appl. No.: 12/281,943

(22) PCT Filed: Mar. 22, 2007
(86) PCT No.: PCT/CA2007/000470

§ 371 Date: Sep. 5, 2008

(30) Foreign Application Priority Data
Mar. 22, 2006 (CA) 2,540,747

(51) Int. Cl. B32B 37/12

(52) U.S. Cl. 156/180; 156/441

(57) ABSTRACT

A method and apparatus for pultrusion of polyurethane resin is provided. The method comprises impregnating fibres with polyurethane resin to produce polyurethane impregnated fibres, and then pulling the polyurethane impregnated fibres through a pultrusion die. The pultrusion die defines a pultrusion path with a heated reaction zone of from about 20 to about 60 cm in length. The apparatus comprises a pultrusion die in combination with a polyurethane resin, the pultrusion die comprising, a body defining a pultrusion path with a heated reaction zone from about 20 to about 60 cm in length.

### FIELD OF INVENTION

The present invention relates to an apparatus and a method for pultrusion. More specifically, this invention provides an apparatus and methods for pultrusion using polyurethane resin.

### BACKGROUND OF THE INVENTION

Polyurethane (PU) resin has been utilized in the pultrusion industry for less than 10 years. PU resins are a family of resins that contain a significant number of urethane linkages within its molecular chains. PU resins are produced by reacting a isocyanate group with an organic compound containing hydrogen atoms that are attached to atoms more electronegative than carbon, such as polyols, in predetermined proportions, which react under the influence of heat or certain catalysts to form a polymer. If significant cross linking occurs, the result is a thermosetting material. As a matrix material in fibre reinforced plastics (FRPs) or composite materials, PU resin has shown tremendous physical properties, particularly in the transverse direction. U.S. Pat. No. 6,420,493 (which is incorporated herein by reference) describes the use of volatile organic compound (VOC) free polyurethane composite resins for composite materials.

During the pultrusion process, reinforcing fibres are pulled first through a device that impregnates or infuses the fibres with resin. These impregnated fibres are then pulled through a die that shapes the material and cures the resin to form a composite with a predetermined dimensional profile. Pultrusion dies of a range of lengths may be used for the preparation of pultruded products. Typically, a long die is required to form and cure the pultruded material (composite) to ensure a stable shape and form as the product exits the die.

The use of a 6 to 8 foot die is disclosed in CA 2,447,745. This length of die is used to ensure that the product properly sets its shape before leaving the die. The use of shorter dies is also known. For example in U.S. Pat. No. 5,716,487, there is disclosed the use of a die of about 76-152 cm (about 30-60 inches) along with epoxy, polyester or vinyl ester resins. The use of this die results in non-steady-sate operating conditions, where portions of the composite material exiting the die are uncured while other portions are cured. This permits further reshaping of the uncured portions by pressure molding.

The use of short prototype pultrusion dies are also know in the art. These dies are used to produce a prototype product on a small scale for testing purposes only. Prototype pultrusion dies are much smaller in diameter and length than known production pultrusion dies and, in contrast to production dies, do not produce a commercial pultruded end product.

### SUMMARY OF THE INVENTION

The present invention relates to an apparatus and a method for pultrusion. More specifically, this invention provides an apparatus and methods for pultrusion using polyurethane resin.

It is an object of the invention to provide an improved Pultrusion production apparatus and method.

According to the present invention there is provided a method for pultrusion of polyurethane resin comprising, infusing fibres with polyurethane resin to produce polyurethane infused fibres, and pulling the polyurethane infused fibres through a pultrusion die defining a pultrusion path with a heated reaction zone which is from about 20 to about 60 cm (from about eight to about twenty four inches) in length. The pultrusion path may comprise an entry zone through which polyurethane infused fibres pass to reach the heated reaction zone and an exit zone through which the polyurethane infused fibres pass after exiting the heated reaction zone. The heated reaction zone may be thermally isolated from the entry zone and the exit zone. Furthermore, the entry and/or exit zone may be cooler than the reaction zone.

The present invention also provides a pultrusion production die, comprising, a body defining a pultrusion path with a heated reaction zone from about 20 to about 60 cm (from about eight to about twenty four inches) in length. The pultrusion path may comprise an entry zone through which polyurethane infused fibres pass to reach the heated reaction zone and an exit zone through which the polyurethane infused fibres pass after exiting the heated reaction zone. The heated reaction zone may be thermally isolated from the entry zone and the exit zone. Furthermore, the entry and/or exit zone may be cooler than the reaction zone.

The present invention pertains to an apparatus comprising a combination of a pultrusion production die and a polyurethane resin, the pultrusion die defining a pultrusion path of from about 20 to about 60 cm (from about eight to about twenty four inches) in length. The pultrusion path may comprise a heated reaction zone. Furthermore, the pultrusion path may comprise an entry zone through which polyurethane infused fibres pass to reach the heated reaction zone and an exit zone through which the polyurethane infused fibres pass after exiting the heated reaction zone. The heated reaction zone may be thermally isolated from the entry zone and the exit zone. Furthermore, the entry and/or exit zone may be cooler than the reaction zone.

The present invention further pertains to a system comprising a combination of a pultrusion production die, a polyol and a polyisocyanate, the pultrusion die defining a pultrusion path of from about 20 to about 60 cm (from about eight to about twenty four inches) in length, or any length therebetween. Preferably, the pultrusion path comprises a heated reaction zone. Furthermore, the pultrusion path may comprise an entry zone through which polyurethane infused fibres pass to reach the heated reaction zone and an exit zone through which the polyurethane infused fibres pass after exiting the heated reaction zone. The heated reaction zone may be thermally isolated from the entry zone and the exit zone. Furthermore, the entry and/or exit zone may be cooler than the reaction zone.

The above described method and apparatus use accelerated reaction kinetics of polyurethane polymerization to cure the polyurethane resin in a production pultrusion die of reduced length. More particularly, the polyurethane resin may have a cure time of about 1 to about 100 seconds at 175° C. or any time therebetween. The finished product created by this method exhibits the same material properties as products processed from the same material in a standard length production die. The accelerated reaction kinetics of the polymerizing system allows for the complete cure of the polyurethane resin in a production pultrusion die of reduced length. Furthermore, the pultrusion process is carried out at a rate that is similar to, or faster than, the rate of conventional pultrusion.

The method of the present invention provides several advantages including, reducing the cost associated with the production of the die, or the material to make the die, due to the reduced length of the die; the time required to fabricate the die is reduced due to the reduced machining involved in die fabrication; the storage costs of the die are reduced due to the smaller space required to house the die when it is not in use; worker fatigue while handling the die is diminished due to the reduced weight of the die; equipment wear and tear while handling the die is diminished due to the reduced weight of the die; costs associated with the production of a mandrel, as required, for the die are diminished due to the shortened length of the die. As with other longer dies, the temperature of the short die can be effectively controlled, to provide rapid heating, cooling, or both, as required. Furthermore, the combination of a short die with a polyurethane resin permits the use of reduced set or cure times of the resin, and the cure times may be adjusted as desired to optimize the properties of the pultruded product. As a result, a pultruded product may be prepared using the methods and apparatus of the present invention that exhibits similar properties to a product produced using a conventional production die of a longer length (e.g. from 0.6 to 1.8 meters (2-6 feet)). However, the time for producing the product, and the energy consumption associated with producing the product are reduced when a short die is used as described herein.

A pultrusion die can be used that does not have thermally isolated zones. However, the use of a pultrusion die with thermally isolated zones is advantageous in that the thermally controlled entrance zone prevents heat from affecting the wetting process so that the heat from the reaction zone has no thermal effect on the process of wetting the glass fibres. Similarly, the thermally controlled finishing zone provides for a better surface finish when thermally isolated from the reaction zone.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a schematic diagram of a pultrusion process in accordance with an embodiment of the present invention.

FIG. 2 shows a perspective view of an example of a non-limiting pultrusion die constructed in accordance with an embodiment of the present invention.

FIG. 3 shows a perspective view of a bottom half of the pultrusion die illustrated in FIG. 2.

FIG. 4 shows a perspective view of an alternate example of a pultrusion die constructed in accordance with an embodiment of the present invention.

FIG. 5 shows a perspective view of a bottom half of the pultrusion die illustrated in FIG. 4.

### DETAILED DESCRIPTION

The present invention relates to an apparatus and a method for pultrusion. More specifically, this invention provides an apparatus and methods for pultrusion using polyurethane resin.

The following description is of a preferred embodiment.

The present invention provides a method for pultrusion of polyurethane resin, comprising, infusing fibres with a polyurethane resin, and pulling the polyurethane infused fibres through a pultrusion die defining a pultrusion path of from about 20 to about 60 cm (from about eight to about twenty four inches) in length, or any length therebetween. The pultrusion path comprises a heated reaction zone.

The present invention also provides an apparatus comprising a combination of a pultrusion production die and a polyurethane resin, the pultrusion die defining a pultrusion path of from about 20 to about 60 cm (from about eight to about twenty four inches) in length, or any length therebetween. The pultrusion path comprises a heated reaction zone.

By using a polyurethane resin it has been observed that fully cured pultruded products may be produced using a shorter pultrusion production die as described herein. The die comprises a heated reaction zone thereby permitting the production of a fully cured final pultrusion product using a die as short as 20 cm (eight inches) in length. The reaction zone may be heated to a temperature between about 150° C. to about 250° C., or any temperature therebetween, for example, 160, 170, 180, 190, 200, 210, 220, 230 and 240° C., or any temperature therebetween to enhance setting or curing of the polyurethane resin in the die. The polyurethane resin preferably has a fast cure time of between about 1 to about 100 seconds at 175° C., or any time therebetween, for example 10, 20, 30, 40, 50, 60, 70 80, and 90 seconds, or any time therebetween. The use of epoxies, unsaturated polyesters, or vinyl esters may not be suitable for use with the pultrusion die of the present invention as pultruded products leaving the die may not be fully cured as described in U.S. Pat. No. 5,716,487 (which is incorporated herein by reference), however, any thermosetting resin that has a fast cure time of between about 1 to about 100 seconds at 175° C., or any time therebetween, would be suitable for use in the present invention.

The die of the present invention is a full production die which produces a fully cured pultruded end product suitable for commercialization, rather than a prototype pultrusion die known in the art which are used to produce a prototype product on a small scale for testing purposes only.

The heated reaction zone may be from about 20 to about 60 cm (from about eight to about twenty four inches) in length, or any length therebetween, for example 22, 24, 26, 28, 30, 32, 34, 36, 38, 40, 42, 44, 46, 48, 50, 52, 54, 56, and 58 cm, or any length therebetween. The reaction zone may be heated to a temperature between about 150° C. to about 250° C., or any temperature therebetween, for example, 160, 165, 170, 175, 180, 185, 190, 195, 200, 205, 210, 215, 220, 225, 230, 235 and 240° C., or any temperature therebetween to enhance setting or curing of the polyurethane resin or other resin in the die. The pultrusion path may further comprise an entry zone through which polyurethane infused fibres pass to reach the heated reaction zone and an exit zone through which the polyurethane infused fibres pass after exiting the heated reaction zone. The heated reaction zone may be thermally isolated from the entry zone and the exit zone. Furthermore, the entry and/or exit zone may be cooled, such that the temperature of the entry and/or exit zone is cooler than the temperature of the reaction zone.

Generally, the temperature of the reaction zone may be from about 2 to about 4 times the temperature of the entry zone, therefore generating a spiked increase in the temperature profile through the pultrusion path on entry to the reaction zone. The temperature of the exit zone may be substantially the same as the temperature in the entry zone or may be up to about 2 times the temperature of the entry zone, such that the temperature profile through the pultrusion path drops on entry into the exit zone and flattens out at a temperature of up to about 2 times the temperature of the entry zone.

In one embodiment, the PU or other fast cure resin may be heated prior to infusion of the fibres, to initiate polymerisation of the resin and ensure that the resin is fully cured when the pultruded product exits the short pultrusion die.

By the term “composite material” it is meant a material composed of reinforcement embedded in a polymer matrix or resin, for example, a polyurethane resin. The matrix or resin holds the reinforcement to form the desired shape while the reinforcement generally improves the overall mechanical properties of the matrix.

By the term “reinforcement” or “fibre” it is meant a material that acts to further strengthen a polymer matrix of a composite material for example, but not limited to, fibres, particles, flakes, fillers, or mixtures thereof. Reinforcement typically comprises glass, carbon, or aramid, however there are a variety of other reinforcement materials, which can be used as would be known to one of skill in the art. These include, but are not limited to, synthetic and natural fibres or fibrous materials, for example, but not limited to polyester, polyethylene, quartz, boron, basalt, ceramics and natural reinforcement such as fibrous plant materials, for example, jute and sisal.

By the term “infuse” it is meant to saturate the voids and interstices of a reinforcement with a resin. The term “infuse” can be used interchangeably with the terms “impregnate”, “wetting” and “wet out” as are commonly used in the art.

The polyurethane resin is made by mixing a polyol component and a polyisocyanate component. Other additives may also be included, such as fillers, pigments, plasticizers, curing catalysts, UV stabilizers, antioxidants, microbiocides, algicides, dehydrators, thixotropic agents, wetting agents, flow modifiers, matting agents, deaerators, extenders, molecular sieves for moisture control and desired colour, UV absorber, light stabilizer and fire retardants.

By the term “polyol” it is meant a composition that contains a plurality of active hydrogen groups that are reactive towards the polyisocyanate component under the conditions of processing. Polyols described in U.S. Pat. No. 6,420,493 (which is incorporated herein by reference) may be used in the polyurethane resin compositions described herein.

By the term “polyisocyanate” it is meant a composition that contains a plurality of isocyanate or NCO groups that are reactive towards the polyol component under the conditions of processing. Polyisocyanates described in U.S. Pat. No. 6,420,493 (which is incorporated herein by reference) may be used in the polyurethane resin compositions described herein.

The present invention also provides a system comprising a combination of a pultrusion production die, a polyol and a polyisocyanate, the pultrusion die defining a pultrusion path of from about 20 to about 60 cm (from about eight to about twenty four inches) in length, or any length therebetween. The pultrusion path comprises a heated reaction zone.

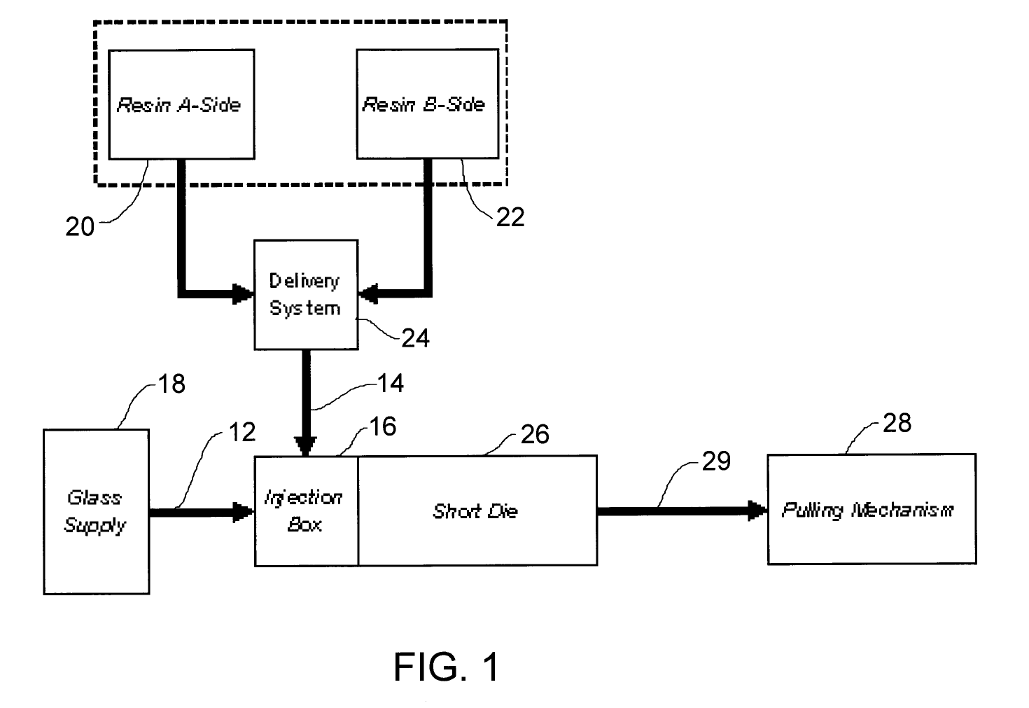

With reference to FIG. 1, a method for pultrusion using a polyurethane (PU) resin is described. The method begins by infusing fibres 12, for example but not limited to reinforcing glass fibres, boron fibres, carbon fibres, ceramic fibres, synthetic fibres, natural fibres, and the like, with the PU resin 14 in an injection box 16 to form infused fibres. This process may also be referred to as “wetting” the fibres 12 with resin 14. The fibres 12 come from a fibre supply 18, for example but not limited to a glass fibre supply as shown in FIG. 1. The PU resin 14 is generally a two-part resin. The fibres 12 are pulled through injection box 16 and pultrusion die 26, by a pulling machine 28. As the resin-fibre mix pass though the pultrusion die 26, the resin cures, and a cured composite material 29 is produced.

The PU resin may be formed by mixing resin precursors contained in separate vessels (e.g. Resin A-side 20, and Resin B-side 22), which are mixed in a delivery system 24 and delivered to injection box 16. For example, Resin A-side 20 may comprise a polyol component and a catalyst and Resin B-side 22 may comprise a polyisocyanate component. Two component chemically thermoset PU composite resins which may be used in the pultrusion method are disclosed in U.S. Pat. No. 6,420,493, (which is incorporated herein by reference) and include for example, but not limited to, Version™ PUL-G 00NT-00-000, Version™ PUL-G 15CC-07-000, Version™ PUL-G 30CC-07-000 and Version™ PUL-G 15C L-01-000 available from RS Technologies—A Division of RS Inc. The two component PU resin once mixed together preferably has a gel time of between about 1 to about 30 minutes at room temperature. This allows thorough mixing of Resin A and Resin B in delivery system 24 and proper “wetting” of fibres 12 in injection box 16, before substantial polymerization of the PU resin takes place.

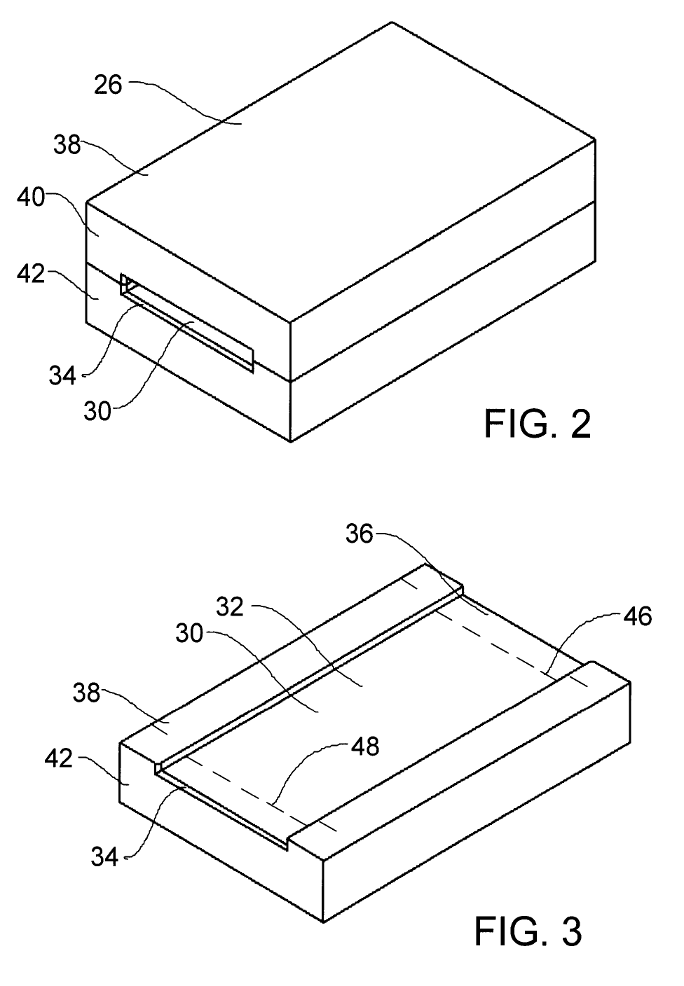

The pultrusion die 26 (see FIGS. 2 and 3) defines a pultrusion path 30 that has a heated reaction zone 32 that is between from about 20 to about 60 cm (about eight and about twenty four inches) in length, or any length therebetween. The reaction zone 32 may be heated to a temperature of about 150° C. to about 250° C., or any temperature therebetween, to enhance curing or setting of the PU resin in the pultrusion die 26.

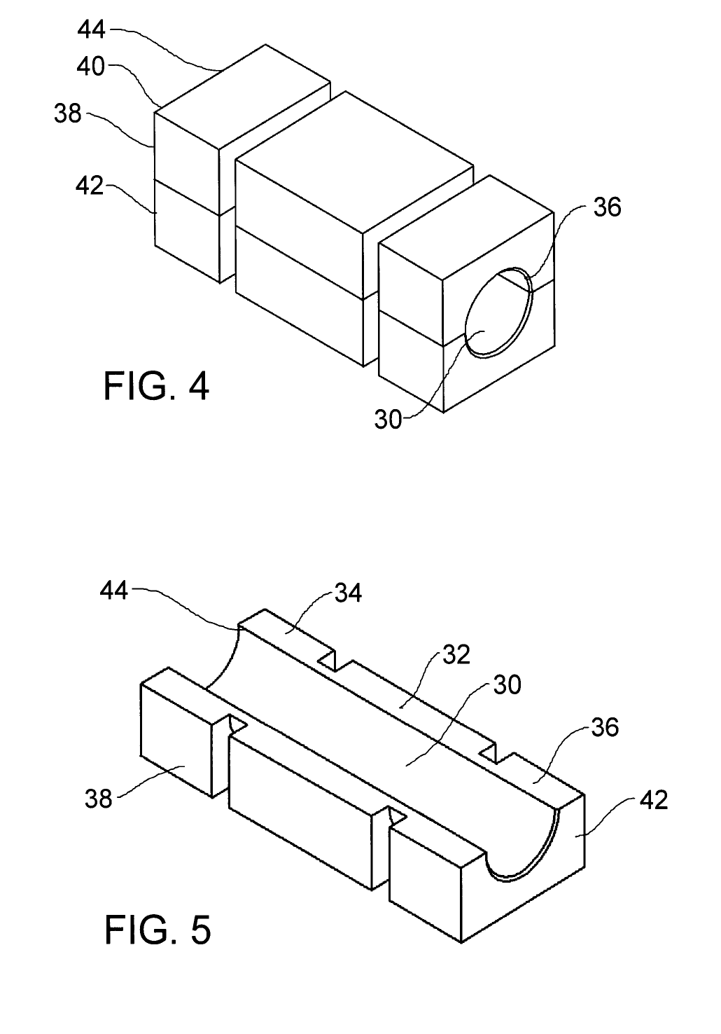

PU infused fibres 12 pass through an entry zone 34 to reach heated reaction zone 32 and then pass through an exit zone 36 through which PU infused fibres 12 pass after exiting heated reaction zone 32. In an alternated example described below, and shown in FIGS. 4 and 5, the heated reaction zone 32 may be thermally isolated from entry zone 34 and exit zone 36. Additionally, the entry zone 34 and/or exit zone 36 may be configured for providing cooling if desired.

Generally, PU chemistry consists of an isocyanate component and a polyol component (referred to jointly as the PU resin) that are mixed together in a specific ratio and allowed to react and cure. The reaction can be described as a stepwise polymerization, which may be contrasted to a polyester reaction, which may be described as a chain polymerization. As is well-known in the art, the kinetics of the PU reaction can be manipulated and controlled through the selection of base materials, chemical additives, and thermal control. In terms of material traveling through pultrusion die 26, the polyurethane reaction can be accelerated to the point that allows full curing to occur in a relatively short linear distance. This allows one to adapt the reaction time to a desired length of pultrusion die 26, within certain limits.

It will be noted that reinforcing fibres 12 may be in the form of a mat to correspond to the cross-section of pultrusion die 26 shown in FIG. 2, whereas reinforcing fibres 12 may also be in the form of strands to correspond to the cross-section of pultrusion die 26 shown in FIG. 4.

With reference to FIGS. 2 and 3, there is shown pultrusion die 26 including a body 38 defining a pultrusion path 30 with a heated reaction zone 32 that is between from about 20 to about 60 cm (eight and twenty four inches) in length. Body 38 has an upper half 40 and a lower half 42 as depicted, although it will be understood that there may be more than two pieces depending on the geometry of the cross-section being pultruded. A pultrusion die may also utilize one or more mandrels (not shown) depending on the geometry of the cross section being pultruded. For example, a mandrel may be used to produce a product with a hollow cross-section. Pultrusion path 30 has an entry zone 34 through which PU infused fibres 12 pass to reach heated reaction zone 32, which may also be referred to as the cure section as it is heated to enhance curing, and exit zone 36 through which PU infused fibres 12 pass after exiting heated reaction zone 32, as described above with reference to FIG. 1. Heated reaction zone 32 is generally heated by external heating means (not shown) at a fixed “cure temperature” to accelerate the polymerisation of PU resin 14 such that it is cured within die 26. The temperature profile across reaction zone 32 is based on the rate at which the material is drawn through pultrusion die 26.

With reference to FIGS. 4 and 5, heated reaction zone 32 of protrusion die 26 is thermally isolated from entry zone 34 and exit zone 36, to form three different thermal zones. Heated reaction zone 32 is externally heated at a fixed “cure temperature” to accelerate the polymerisation of PU resin 14 such that it is cured within die 26. Entry zone 34 and exit zone 36, on the other hand, may be externally cooled. Entry zone 34 acts as a barrier zone between die 26 and injection box 16 (seen in FIG. 1) to prevent premature curing, while exit zone 36 acts as a finishing section, and may be cooled to enhance the surface quality of the finished product. The temperature profile across reaction zone 32 is based on the rate at which the material is drawn through pultrusion die 26.

As depicted in FIGS. 4 and 5, in order to take advantage of the compressed length of die 26, body 38 may be segmented to prevent heat transfer from one section of the die to another, such that entry zone 34, heated reaction zone 32 and exit zone 36 are thermally separated. This segmentation creates physical barriers to reduce heat transfer through body 38, such that the elevated temperature of reaction zone 32 does not affect entry zone 34 and exit zone 36, which may also be externally cooled. The segmentation is achieved with no adverse affects to the structural integrity of body 38 of pultrusion die 26, and in particular, the integrity of pultrusion path 30.

It will be noted that the embodiment of FIGS. 2 and 3 may also be adapted to include zones of different temperature. Referring to FIG. 3, the actual boundaries of each zone will depend on the particulars of the application. For example, dotted lines 46 and 48 show possible regions of different temperature of die 26.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A method for pultrusion of polyurethane resin comprising,
impregnating fibres with polyurethane resin to produce polyurethane impregnated fibres; and
pulling the polyurethane impregnated fibres through a pultrusion die defining a pultrusion path with a heated reaction zone of from about 20 to about 60 cm in length.

2. The method as defined in claim 1, wherein the pultrusion die comprises an entry zone through which the polyurethane impregnated fibres pass to reach the heated reaction zone and an exit zone through which the polyurethane impregnated fibres pass after exiting the heated reaction zone.

3. The method as defined in claim 2, wherein the heated reaction zone is thermally isolated from the entry zone and the exit zone.

4. The method as defined in claim 1, wherein the reaction zone is from about 40 to about 60 cm in length.

5. A pultrusion die, comprising, a body defining a pultrusion path with a heated reaction zone from about 20 to about 60 cm in length.

6. The pultrusion die as defined in claim 5, wherein the pultrusion path has an entry zone through which polyurethane impregnated fibres pass to reach the heated reaction zone and an exit zone through which the polyurethane impregnated fibres pass after exiting the heated reaction zone.

7. The pultrusion die as defined in claim 6, wherein the heated reaction zone is thermally isolated from the entry zone and the exit zone.

8. The pultrusion die as defined in claim 5, wherein the reaction zone is from about 40 to about 60 cm in length.

9. An apparatus comprising a combination of a pultrusion die and a polyurethane resin, the pultrusion die defining a pultrusion path having a heated reaction zone of from 20 to about 60 cm in length.

10. The apparatus of claim 9, wherein the heated reaction zone is from about 40 to about 60 cm in length.

11. A system comprising a combination of a pultrusion production die, a polyol and a polyisocyanate, the pultrusion die defining a pultrusion path having a heated reaction of from about 20 to about 60 cm in length.

12. The system of claim 11, wherein the heated reaction zone is from about 40 to about 60 cm in length.
